(19) United States
(12) Patent Application Publication
(10) Pub. No.: US 2019/0231487 A1
(43) Pub. Date: Aug. 1, 2019

(54) ORTHODONTIC ANTERIOR BITE RAMP

(71) Applicant: Todd Evan Dickerson, Phoenix, AZ (US)

(72) Inventor: Todd Evan Dickerson, Phoenix, AZ (US)

(21) Appl. No.: 16/363,745

(22) Filed: Mar. 25, 2019

Related U.S. Application Data
(63) Continuation of application No. 15/880,822, filed on Jan. 26, 2018.

(51) Int. Cl. A61C 7/14; A61C 7/36; A61C 7/02

(52) U.S. Cl. CPC A61C 7/141; A61C 7/02; A61C 7/36

(57) ABSTRACT

An orthodontic bite ramp has a body having an anterior base for bonding attachment to the lingual surface of an upper tooth; an occlusal surface extending lingually from the base to provide a stop limiting upward movement of a patient's lower teeth; and a vertical slot in the lingual aspect of the bite ramp. The vertical slot divides the body into two lateral wings that can be compressed by application of a lateral compressive force to deform the base and thereby release the bite ramp from the tooth. Optionally, a bonding pad can be secured to the base for bonding attachment to the lingual surface of an upper tooth.

### RELATED APPLICATION

The present application is a continuation of the Applicant's pending U.S. patent application Ser. No. 15/880,822, entitled “Orthodontic Anterior Bite Ramp,” filed on Jan. 26, 2018.

### BACKGROUND OF THE INVENTION

### Field of the Invention

The present invention relates generally to the field of orthodontic appliances. More specifically, the present invention discloses an orthodontic bite ramp for use on anterior teeth.

### Statement of the Problem

A deep bite is a common clinical presentation in orthodontics. In this condition, the lower anterior teeth are covered or concealed partially or entirely in the vertical direction because the upper anterior teeth overlap them. This deep bite is often due to the over-eruption of the lower anterior teeth.

Adding composite bonding material or some other material over the buccal surface of posterior teeth is a common way to disclude the upper and lower teeth. This is commonly referred to as a posterior “bite ramp” and is the quickest, easiest way to separate teeth. Separation decreases or removes opposing teeth from touching one another. This disclusion artificially opens the bite so orthodontic brackets may be placed where it would otherwise not be possible to do so safely or comfortably. In addition, this protects the opposing dentition from forcefully coming into contact with the braces or brackets. Damage in the form of chipping and abrasion is avoided by having the teeth separated. The negative to using posterior bite ramps is that the point of first contact biomechanically has an intrusive force and effect on the posterior teeth, which results in an undesired extrusive effect on the lower anterior teeth.

In contrast, anterior bite ramps are placed behind maxillary anterior teeth to disclude the posterior teeth. The lower anterior teeth contact the occlusal surface of the bite ramp, thereby adding a vertical intrusive force in the direction that the mandibular teeth need to move to idealize alignment. However, the problem with current anterior bite ramps is they are bulky and difficult to precisely position when using composite to fabricate either freehand or with a template. In addition, metal anterior bite ramps are difficult to place and position for most orthodontists, so doctors rarely use these.

Unlike the facial aspect of teeth, the palatal aspects of the anterior teeth have extreme variability. This includes nearly flat to extremely pronounced marginal ridges, a flat to extremely concave bonding surface, small to interfering cingulum, and emergence profile differences between various shaped teeth ranging from palatal to facial presentations. It is extremely difficult to factor all of these individual variations when placing attachments on the palatal aspect of a tooth with current metal designs.

An even bigger problem with both composite-fabricated bite ramps and metal anterior bite ramps is that they are extremely difficult and time-consuming to remove. Removal is hindered by the anatomical variation described above. Also, access on the palatal aspect of the anterior teeth makes most traditional removal techniques challenging at best, and useless at worst. In some cases, there is no alternative in metal anterior bite ramp removal other than grinding the bracket off, which is uncomfortable and time-consuming. The traditional torque removal technique used on brackets placed on the facial aspect of teeth is anatomically impossible in some cases, as is using a sharp lingual cutter and attempting to place the cutting edge at the tooth to the bonding pad surface. In the case of composite anterior bite ramps, the volume of composite to be removed is significant and time-consuming. There is such a large amount of composite to grind through in many cases, the dust generated may be detrimental to a patient's breathing and health.

The prior art in field of orthodontics also includes a variety of orthodontic brackets for engaging an archwire. These brackets generally have a structure and functionality that is quite different than a bite ramp. Vertical slots are commonly used in such orthodontic brackets. The slot is as wide as possible to decrease the amount of bracket touching the orthodontic wire. The less wire-to-bracket contact, the less resistance the bracket has to movement of the wire, which in turn increases the ability of the wire to move teeth. The wide slot creates what are known as “wings” on the bracket on either side of the vertical slot. These wings are usually made as small as possible leaving enough undercut to allow an elastic tie to be engaged and hold an orthodontic wire in place.

### Solution to the Problem

The present invention addresses these shortcomings in the field of orthodontic bite ramps by providing an anterior bite ramp having a vertical slot on its posterior aspect that creates two opposing lateral wings. By including a vertical slot in the bite ramp, we are able to have the benefit of creating disclusion in the anterior, and adding an intrusive effect when mandibular teeth contact the bite ramp. When the bite has been leveled to ideal, the bite ramp can easily be removed by compressing the lateral wings to peel the bite ramp from the tooth.

### SUMMARY OF THE INVENTION

This invention provides an orthodontic bite ramp having a body with an anterior base for bonding attachment to the lingual surface of an upper tooth; an occlusal surface extending lingually from the base to provide a stop limiting upward movement of a patient's lower teeth; and a vertical slot in the lingual aspect of the bite ramp. The vertical slot divides the body into two lateral wings that can be compressed by application of a lateral compressive force to deform the base and thereby release the bite ramp from the tooth. Optionally, a bonding pad can be secured to the base for bonding attachment to the lingual surface of an upper tooth.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a top axonometric view of the bite ramp 20.

FIG. 2 is a bottom axonometric view of the bite ramp 20.

FIG. 3 is a right side axonometric view of the bite ramp 20 attached to an upper anterior tooth 10.

FIG. 4 is a rear view of the bite 20 attached to a tooth 10.

FIG. 5 is a right side view of a jig or gauge 30 being used to position a bite ramp 20 with respect to a tooth 10 during bonding.

FIG. 6 is a right side view of the bite ramp 20 attached to an upper tooth 10 for limiting upward movement of a lower tooth 12.

FIG. 7 is an axonometric view showing the wings 26, 27 of the bite ramp 20 being compressed to release the bit ramp 20 from the tooth 10.

FIG. 8 is a rear view of an alternative embodiment of a bite ramp 20 having two vertical slots 25.

### DETAILED DESCRIPTION OF THE INVENTION

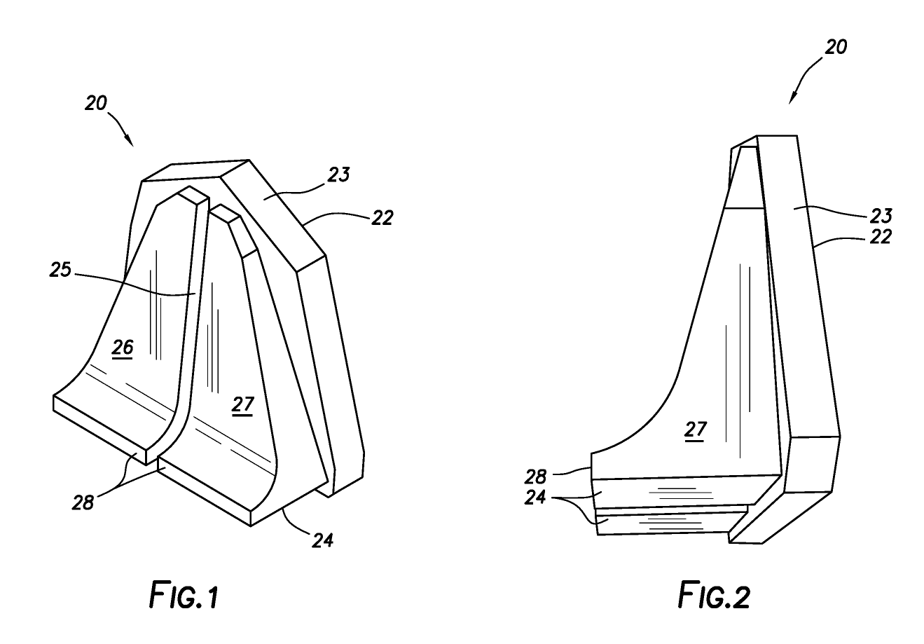

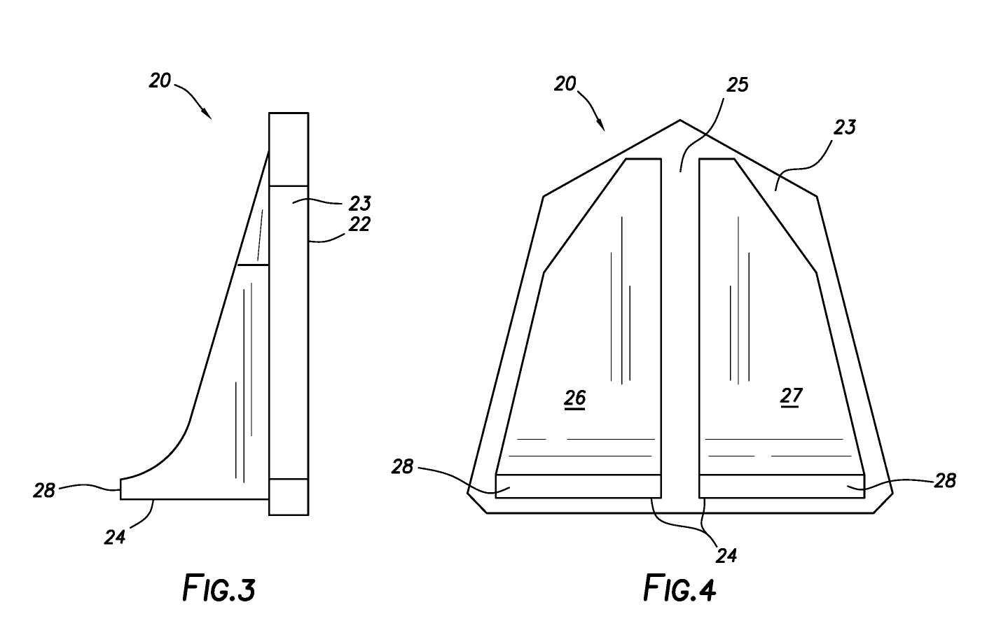

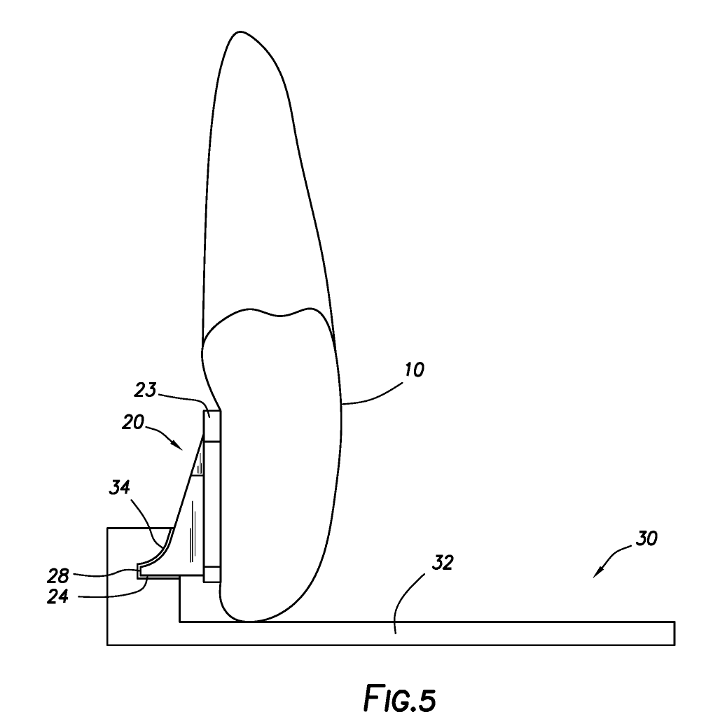

FIGS. 1 and 2 illustrate an embodiment of the bite ramp 20 in the present invention. The body of the bite ramp 20 includes a bonding base 22 on its anterior surface for bonding attachment to the lingual surface of a tooth 10. Typically, this would an upper anterior tooth. FIGS. 3 and 4 show the bite ramp 20 attached to the lingual surface of an anterior tooth 10. Optionally, the bonding base 22 can include a bonding pad 23 as shown in the accompanying figures that can be contoured to the profile of the lingual surface of the tooth 10. The bite ramp can be attached to the tooth 10 using cement, adhesive or other bonding agents. The bonding pad 23 can extend slightly beyond the edges of the bite ramp 20, as shown in the drawings. Alternatively, the bite ramp 20 could extend only to the edges of the bonding pad 23, or as close as possible to the edges of the bonding pad 23, to help ensure complete removal of the entire appliance from the tooth 10 in one piece.

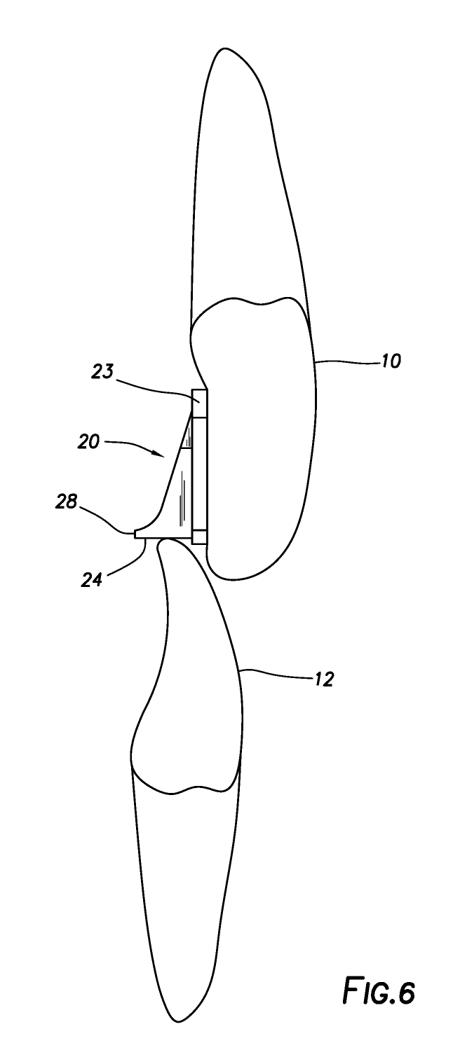

The bite ramp 20 also has an occlusal surface 24 extending lingually from the bonding base 22 as shown in FIGS. 3-6. The occlusal surface 24 provides a stop to limit upward movement of the patient's lower teeth. As the mandible closes, the occlusal tip of a lower tooth 12 comes into contact with this occlusal surface 24 of the bite ramp 20 and thereby limits further upward movement of the jaw, as depicted in FIG. 6.

When viewed is a vertical plane normal to the bonding base 22, the bite ramp 20 can has a generally triangular shape with the hypotenuse running between the gingival end of the bonding base 22 and the lingual end of the occlusal surface 24 to define the lingual aspect of the bite ramp 20. In other words, the bite ramp 20 is tapered from its bonding base 22 in a vertical plane normal to the bonding base 22 to its lingual edge 28 at the rear of the bite ramp 20.

A vertical slot 25 bisects this lingual aspect of the bite ramp 20 as illustrated in FIG. 4. Two opposing wings 26, 27 are defined on either side of this vertical slot 25. Preferably, the vertical slot 25 extends completely through the body of the bite ramp 20 to the bonding pad 23. Alternatively, the vertical slot 25 could extend only part of the way into the body of the bite ramp 20.

FIG. 5 is side view of a jig 30 being used to position a bite ramp 20 with respect to a tooth 10 during bonding. The jig 30 has an elongated horizontal arm 32 that contacts the tip of the tooth 10 to provide a fixed point of reference in setting the vertical elevation of the bite ramp 20 with respect to the tooth 10. The posterior portion of the jig 30 extends upward from the arm 32. A notch 34, recess or protrusion in the posterior portion of the jig 30 engages the lingual edge 28 of the bite ramp 20 so that the vertical elevation of the notch 34 above the top edge of the horizontal arm 32 determines the vertical position of the bite ramp 20 on the tooth 10.

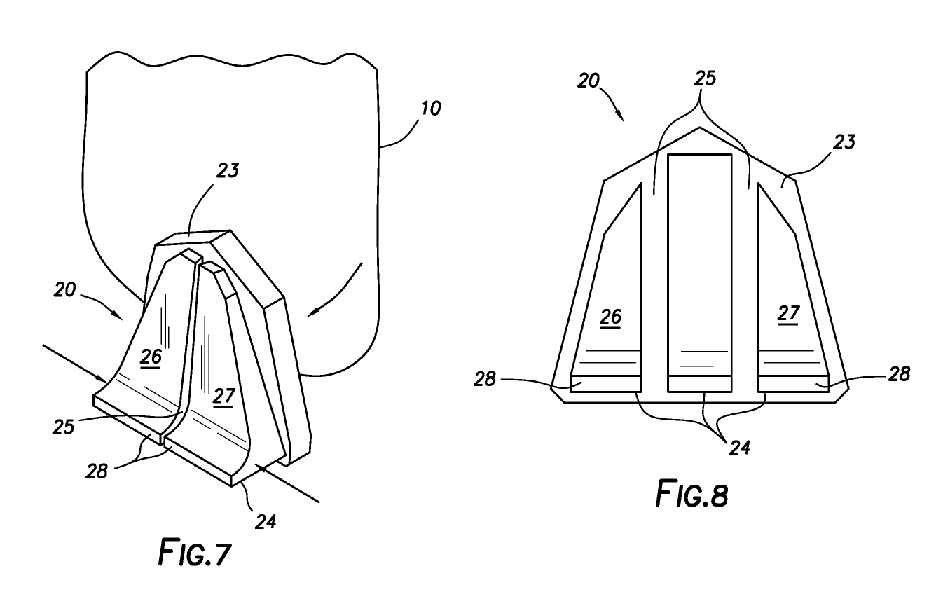

After the bite ramp 20 has been bonded to a tooth 12, a period of orthodontic treatment follows. At the end of treatment, the bite ramp 20 must be removed. With the present invention, the doctor can quickly and easily remove the bite ramp 20 using pliers or the like to exert a lateral compressive force on the wings 26, 27. This squeezes the wings 26, 27 together and collapses the vertical slot 25. The bonding base 22 is deformed (e.g., the bonding pad 23 is peeled away from the tooth 10) in this process, thereby releasing the bite ramp 20 from the tooth 10. FIG. 7 shows the wings 26, 27 of the bite ramp 20 being compressed to release the bit ramp 20 from the tooth 10.

FIG. 8 is a rear view of an alternative embodiment of a bite ramp 20 having multiple vertical slots 25. In this embodiment, the vertical slots 25 run generally parallel to one another. Applying a lateral compressive force to squeeze the outermost wings 26, 27 collapses both of the vertical slots 25. This tends to lift the edges of the bonding pad 23 away from the tooth 10 to facilitate removal of the bite ramp 20.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method of orthodontic treatment comprising:
bonding an orthodontic bite ramp to the lingual surface of a patient's upper anterior tooth, wherein the orthodontic bite ramp has:
(a) a body having an anterior base for bonding attachment to a tooth; an occlusal surface extending lingually from the based; and a lingual aspect; and
(b) a slot in the lingual aspect of the orthodontic bite ramp dividing the body into lateral wings separated by the slot;
limiting closure of the patient's mandible by employing the occlusal surface of the orthodontic bite ramp as a stop limiting upward movement of the patient's lower teeth; and
debonding the orthodontic bite ramp by compressing the wings of the orthodontic bite ramp together by application of a lateral compressive force to deform the base and thereby release the orthodontic bite ramp from the tooth.

2. The method of claim 1 wherein the slot is substantially vertical.

3. The method of claim 1 wherein the base of the orthodontic bite ramp further comprises a bonding pad and wherein the slot extends through the body of the orthodontic bite ramp to the bonding pad.

4. The method of claim 1 further comprising positioning the orthodontic bite ramp with respect to a tooth during bonding of the orthodontic bite ramp to the tooth using a positioning jig having a notch for removably engaging the lingual edge of the base of the orthodontic bite ramp.

5. The method of claim 4 wherein the body of the orthodontic bite ramp has a cross-section in a vertical plane perpendicular to the base tapering rearward from the base to the lingual edge.

6. The method of claim 1 wherein the slot extends the entire inciso-gingival length of the body.

7. The method of claim 1 wherein the orthodontic bite ramp comprises a plurality of slots dividing the body into lateral wings.

8. A method of orthodontic treatment comprising:
bonding an orthodontic bite ramp to the lingual surface of a patient's upper anterior tooth, wherein the orthodontic bite ramp has:
(a) a body having an anterior base for bonding attachment to a tooth; an occlusal surface extending lingually from the based; and a lingual aspect;
(b) a bonding pad secured to the based for bonding attachment to the lingual surface of a tooth;
(c) a substantially vertical slot in the lingual aspect of the orthodontic bite ramp dividing the body into lateral wings separated by the slot; and
limiting closure of the patient's mandible by employing the occlusal surface of the orthodontic bite ramp as a stop limiting upward movement of the patient's lower teeth; and
debonding the orthodontic bite ramp by compressing the wings of the orthodontic bite ramp together by application of a lateral compressive force to deform the bonding pad and thereby release the orthodontic bite ramp from the tooth.

9. The method of claim 8 wherein the slot extends through the body of the orthodontic bite ramp to the bonding pad.

10. The method of claim 8 further comprising positioning the orthodontic bite ramp with respect to a tooth during bonding of the orthodontic bite ramp to the tooth using a positioning jig having a notch for removably engaging the lingual edge of the base of the orthodontic bite ramp.

11. The method of claim 10 wherein the body of the orthodontic bite ramp has a cross-section in a vertical plane perpendicular to the base tapering rearward from the base to the lingual edge.
